(19) United States
(12) Patent Application Publication
(10) Pub. No.: US 2024/0307738 A1
(43) Pub. Date: Sep. 19, 2024

(54) DEVICE FOR ASSISTING SPORTS COACH AND METHOD IMPLEMENTING THE SAME

(71) Applicant: TRACK160 LTD., Tel- Aviv (IL)

(72) Inventors: Michael TAMIR, Tel Aviv (IL); Tamir ANAVI, Kfar Saba (IL); Ariel GREISAS, Mazkeret Batia (IL); Michael BIRNBOIM, Holon (IL); Slava CHERNOI, Petach-Tikva (IL); Alex YUDASHKIN, Tel-Aviv (IL)

(21) Appl. No.: 18/578,446

(22) PCT Filed: Jul. 14, 2022
(86) PCT No.: PCT/IL2022/050765

§ 371 Date: Jan. 11, 2024

Related U.S. Application Data
(60) Provisional application No. 63/222,019, filed on Jul. 15, 2021.

(51) Int. Cl. A63B 24/00

(52) U.S. Cl. CPC A63B 24/0021; A63B 2024/0025; A63B 2024/0028; A63B 2024/0056; A63B 2243/0025

(57) ABSTRACT

A computer-implemented system for assisting a sports game analyst comprises: a user interface operable to interact with a user; a memory storing records of positions of sports game players and game object within the playing ground; a processor cooperatively operable with the user interface and memory. The processor is configured for performing a trained artificial intelligence algorithm. The processor is configured for inquiring real-time positions of sports game players and game object and predicting future positions of the sports game players and game object within the playing ground by performing the artificial intelligence algorithm.

### FIELD OF THE INVENTION

The present invention relates to systems and methods for short-term prediction and, more particularly, to systems and methods for predicting and analysis through scenarios of sports games.

### BACKGROUND OF THE INVENTION

Sports is a domain that has grown significantly over the last 20 years to become a key driver of many economies, while at the same time, impacting on our social and cultural fabric. According to a recent report, the estimated size of the global sports industry is $1.3 trillion and has an audience of over 1 billion, who may attend matches to support their favorite teams, bet in various online or offline markets, or watch games on the television for pure entertainment. Sports employ over 1 million jobs in the UK alone, with those involved either playing games, managing teams, or looking after the health and fitness of players. At the core of these economic and social impacts, are the individuals, players, and teams involved. Indeed, as we will demonstrate in this paper, predicting and optimizing the performance in sports are challenging problems but, so far, such problems have largely been dealt with by domain experts (e.g., coaches, managers, scouts, and sports health experts) with basic analytics. Specifically, the application focuses on team sports as they present the most difficult challenges and tend to have the greatest audience and economic benefit.

We define a team sport as a game that typically involves two teams playing against each other, each composed of a set of players with their individual roles and abilities. There are many uncertainties in team sports that affect the final outcome and performance of the teams. These decisions range from team selection, tactics (e.g., choosing where players should be placed on a football field), player transfers (e.g., choosing which players should be sold to or bought from another team), and planning training sessions (e.g., to help players recover from injuries or improve collective performance of a team). The results of such decisions can sometimes be quickly obtained and learnt from (e.g., tactics may fail or succeed during a live game) or come through over a long period of time (e.g., a player may recover differently based on different long-term training regimes or preparatory matches).

In recent years, the field of team sports (teams, governing bodies, academies, etc.) has adopted a range of technologies that collect large amounts of data from training and matches that include the movement of players during games, their health statistics, and their actual performance during such games. Players train and compete while being monitored by a number of sensors to gain more information about performances. This helps coaches and managers optimize training sessions and further improve performance. For example, companies such as Catapult and Chyron-Hego specialize in collecting and distributing sports data to teams and media outlets as post-match statistics but also in real time. Major teams around the world already use a variety of datasets to make decisions and improve their on-field performances. There are a number of key decisions in the team sports process that affect performance both in-game and post-game. These decisions include player recruitment, tactics, players selection, developing youth players, and managing injuries as well as in game players substitutes selection and tactics changes.

This tends to lead to increases in prize money, higher proportions of TV rights, and more sponsorship deals. For example, the promotion of an English Championship football team to the English Premier League (EPL) is worth £200 million in extra revenuesProfessional betting companies use such datasets to exploit inefficiencies in the sports betting markets and maximize their profits. Hedge funds who use the sports gambling markets as a way to make investments exploit these sports betting market inefficiencies.

### SUMMARY OF THE INVENTION

It is hence one object of the invention to disclose a computer-implemented system for assisting a sports game analyst with in game and post-match decisions. The aforesaid device comprises: (a) a user interface operable to interact with a user; (b) a memory storing records of positions of sports game players and game object within said playing ground; (c) a processor cooperatively operable with said user interface and memory; said processor configured for performing an artificial intelligence algorithm; (d) a sensor arrangement configured for detecting real-time positions of sports game players and game object within said playing ground. The processor is configured for inquiring real-time positions of sports game players and game object and predicting future positions of said sports game players and game object within said playing ground by performing said artificial intelligence algorithm.

Another object of the invention is to disclose the artificial intelligence algorithm comprising a generative adversarial network algorithm trained by steps of: (a) inquiring records of positions of said sports game players and game object within said playing ground for a first predetermined period of time; (b) generating successive probable positions of said sports game players and game object within said playing ground for a second predetermined period of time within said first predetermined period of time; (c) discriminating between corresponding generated probable positions and said records; and (d) validating correctness of said generated probable positions relative to said real-time positions.

A further object of the invention is to disclose the system comprising a sensor arrangement configured for detecting real-time positions of sports game players and game object within said playing ground and transmitting obtained real-time positions of sports game players and game object within said playing ground to said processor.

A further object of the invention is to disclose the generative adversarial network algorithm comprising parameterizing said successive probable positions by applying at least one predetermined sports game technique.

A further object of the invention is to disclose the sport game which is soccer.

A further object of the invention is to disclose the sports game technique selected from the group consisting of a single lunge, a rabona, a stepover, a Cruyff turn, an inside rollover, a Matthews cut, an ellastico, an around-the-world, a Ronaldo chop and any combination thereof.

A further object of the invention is to disclose the memory comprising personal records of sports game players.

A further object of the invention is to disclose the personal records selected from the group consisting of ball control skills, dribbling skills, tackling skills, heading skills, dead ball skills, passing accuracy, body control skills, spatial awareness, tactical knowledge, risk assessment, physical endurance, balance and coordination, speed and any combination thereof.

A further object of the invention is to disclose the system configured for modelling a fake game between rival teams and generate a game outcome on the basis of said personal records of said rival teams.

A further object of the invention is to disclose the generative adversarial network algorithm comprising parameterizing said successive probable positions by applying said personal records of sports game players and selecting a candidate to be a substitute for a given player in said sports game.

A further object of the invention is to disclose the applying said personal records of sports game players comprising outputting game recommended formation and scenario of a sports game performed by alternative game players characterized by said personal records.

A further object of the invention is to disclose the game formation selected from the group consisting of 4-5-1, 4-3-3, 4-2-3-1, 3-5-2, 4-4-2, 3-4-2 and any combination thereof.

A further object of the invention is to disclose the game scenario selected from the group consisting of a tiki-taka scenario, a park-the-bus scenario, a counter-attack scenario, a high-press scenario, a long-ball scenario, a bunker scenario, and any combination thereof.

A further object of the invention is to disclose the sensor arrangement comprising a sensor selected from the group consisting of video cameras, a radar and wearable sensors, a GPS wearable sensor, an RFID beacon and any combination thereof.

A further object of the invention is to disclose the system configured for outputting recommendation to the coach indicating which players to substitute during a match, optimal team line-up for the coming match.

A further object of the invention is to disclose the system configured for modelling a dribbling-and-losing-the-ball game episode performed by one player by and predicting an alternative outcome of said episode performed by another player.

A further object of the invention is to disclose the system configured for modelling a scenario of a team attack if player A plays instead of player B.

A further object of the invention is to disclose the system configured for generating a scenario of a fake game and real-time predicting a game total to diminish game latency.

A further object of the invention is to disclose the computer-implemented method of assisting a sports game analyst is disclosed. The aforesaid method comprises steps of: (a) providing a computer-implemented system for assisting a sports game analyst; said system comprising: (i) a user interface operable to interact with a user; (ii) a memory storing records of positions of sports game players and game object within said playing ground; (iii) a processor cooperatively operable with said user interface and memory; said processor configured for performing an artificial intelligence algorithm; (iv) a sensor arrangement configured for detecting real-time positions of sports game players and game object within said playing ground; (b) inquiring records of real-time positions of said sports game players and game object within said playing ground for a third predetermined period of time; (c) predicting probable future positions of said sports game players and game object within said playing ground by performing said artificial intelligence; (d) outputting predicted future positions of said sports game players and game object within said playing ground via said user interface.

### BRIEF DESCRIPTION OF THE DRAWINGS

In order to understand the invention and to see how it may be implemented in practice, a plurality of embodiments is adapted to now be described, by way of non-limiting example only, with reference to the accompanying drawings, in which

FIG. 1 is a schematic diagram of a computer-implemented system for assisting a sports game analyst;

FIG. 2 is a schematic diagram of a generative adversarial network algorithm;

FIG. 3 is a flowchart of a method of training a generative adversarial network in a computer-implemented system for assisting a sports game analyst; and

FIG. 4 is a flowchart of a method of assisting a sports game analyst.

### DETAILED DESCRIPTION OF THE INVENTION

The following description is provided, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide a computer-implemented system for assisting a sports game analyst and a method of doing the same.

The present invention is designed for analyzing sports team games and assisting in sport team game management and training process. The invention is applicable with modifications to all team sports (rugby, basketball, netball, baseball, cricket) but, at the moment, is directed to soccer as the most popular sports type.

Location data of the game players and the game object used to extract players fitness and performance parameters as well as teams' tactical analysis, are measured by alternative methods:
Methods used to calculate the data—3 families—GPS based sensors, radars and optical tracking, also hybrid methods;
Current tracking data relates to post-match analysis and real time operation with a variety of latency figures;
Game events (goals, corners, yellow cards, red cards, substitutions, free kicks, throw-ins, penalties, kick off, line ups) are currently detected and tagged either manually (most cases) or automatically (Track 160)

The purpose of this invention is to provide a system and a method to propose predictions and gain tactical and players personal insights based on the tracking data explained above both for in game decisions and post-match analysis and player education.

Another application based on the methods described below is the latency feature for real time versions of the software which is a significant parameter mainly for broadcast and sports betting application. It is possible to generate “future fake games” and thus shorten or even null the latency.

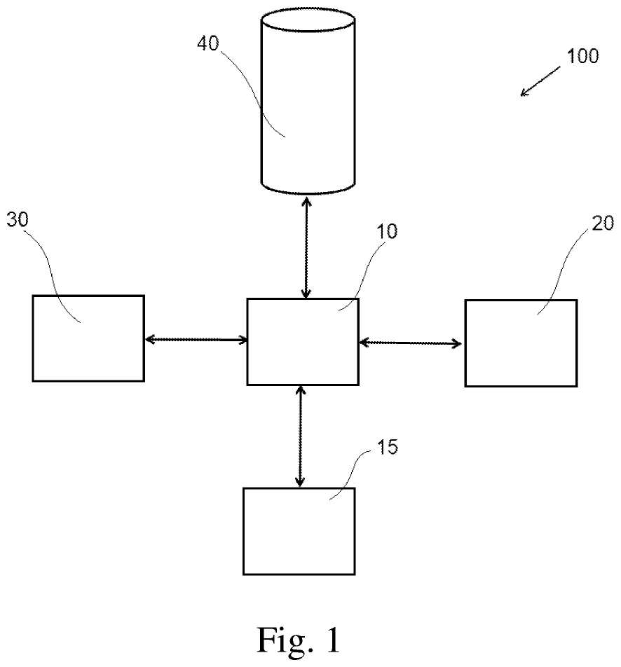

Reference is now made to FIG. 1 presenting a schematic diagram of computer-implemented system 100 for assisting a sports game analyst. System 100 comprises a processor 10 provided with software 15 including inter alia a generative adversarial network (GAN) algorithm. The training procedure is disclosed below. The data patterns for training the generative adversarial network can be obtained in real time or preliminary stored in memory 40. System 100 is designed for detecting positions of sport game players and a game object such as a ball in soccer, volleyball, basketball within a playground are detected by a sensor arrangement which can include a camera, a radar or like. The records of past sports games are used for training GAN. Detection and usage of game events such as goals, corners, yellow or red cards for in and post-game insights are also in the scope of the invention. Generally, on the input of real-time positions of sport game players and a game object provided by sensor arrangement to the GAN algorithm. As mentioned above, the GAN includes a generative part which generates probable future positions of the abovementioned players and game object (candidate data patterns). The candidate data patterns are discriminated by a discriminating part and validates correctness of generated data patterns.

System 100 is configured for outputting recommendations to the coach. Specifically, on the basis of the database of personal records of the team members (physique, trauma history, sporting fitness), system is able to preliminary analyze sports game coming up in the future and recommend an optimal team formation and line-up applicable to the sports game coming up in the future, in reference to the competitor or opponent. During the game, system 100 analyzes the current game in real time and outputs recommendations concerning the players to be substituted in the course of the game, change of game tactics and responses to “what if” scenarios for in and post-game analysis.

System 100 is pre-programmed for modelling sports game as a sequence of standard game formations, tactics and line-up for game player education. For example, the system enables modelling queries such as what happens if soccer player X instead of dribbling and losing the ball, would have successfully passed the ball to soccer player Y? Would the team still lose the ball? According to another scenario, the system is preprogrammed for applying personal records of the team members to a game disposition and modelling the attack or the outcome of the whole game depending on team formation and substitution of specific game players.

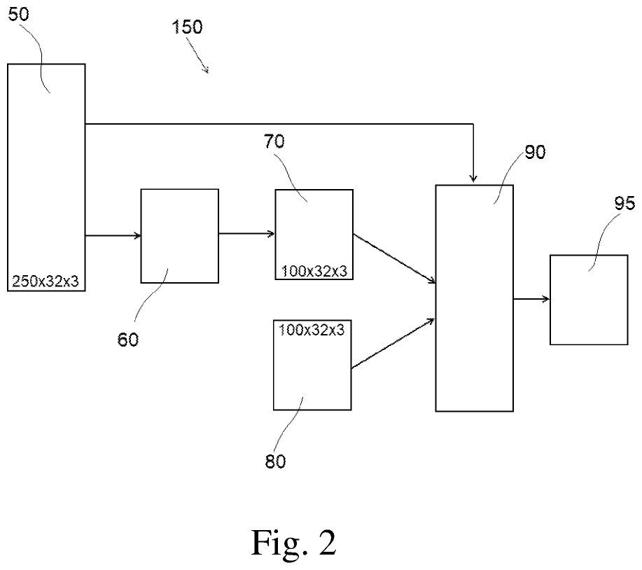

Reference is now made to FIG. 2 presenting a schematic diagram of algorithm 150 of generative adversarial network (GAN). Algorithm 150 is combined with neural networks 60 and 90. Generative neural network 60 handles with prestored datasets 50 of locations of all players in the field in the past 10 seconds and generates the datasets 70 relating to predicted locations of the same players in the next 5 seconds. Numbers withing the diagram boxes refer to the dataset format handled in the present algorithm. Discriminative neural network 90 discriminates between predicted datasets 70 and really obtained datasets of players' locations generated candidate datasets from the true data distribution. The discrimination result is signed by numeral 95.

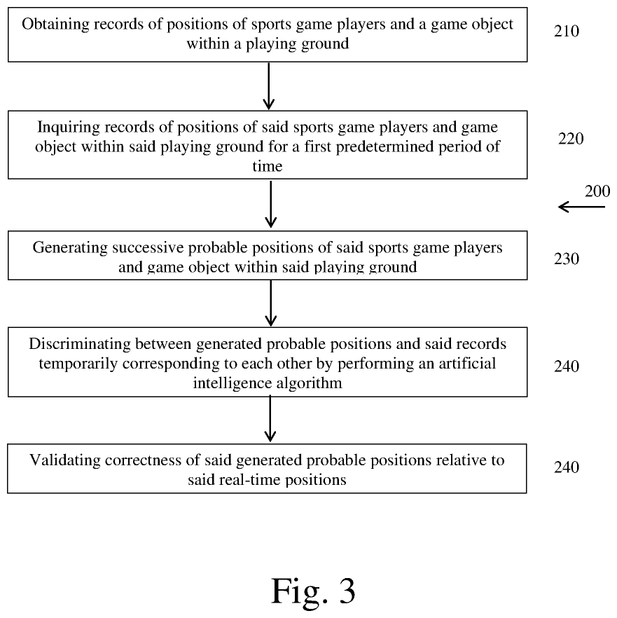

Reference is now made to FIG. 3 presenting a flowchart of method 200 of training a generative adversarial network in a computer-implemented system for assisting a sports game analyst. According to one embodiment of the present invention, the training procedure starts with step 210 of obtaining records of positions of sports game players and a game object within a playing ground based on the past games. The aforesaid records corresponding to first predetermined time period 11 (for example, 10 sec) are inquired by processor at step 220. The generative part of the GAN algorithm generates probable positions of said sports game players and game object within said playing ground for second predetermined time period 12 within said first predetermined time period 11 (step 230). The discriminating part of GAN algorithm discriminates between the generated probable positions and records temporarily corresponding to each other (step 240). Finally, correctness of the generated probable positions is validated (step 250). In the course of the training procedure, correctness of generated candidate data patterns is validated on the base of the successive record (for example, an image frame belonging to the records of the past sports games).

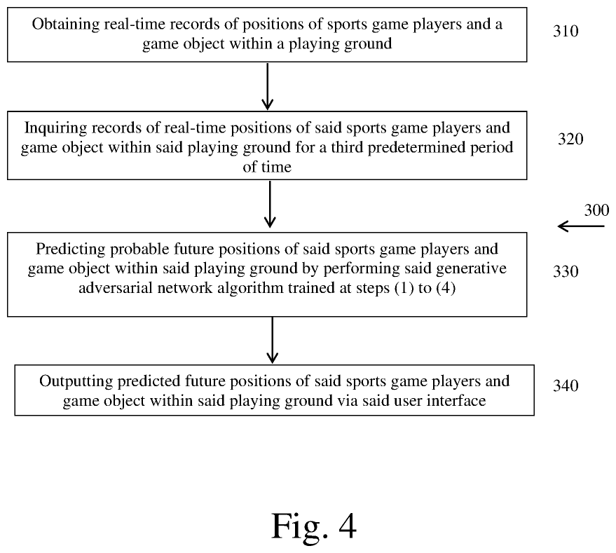

Reference is now made to FIG. 4 presenting a flowchart of method 300 of assisting a sports game analyst. The method starts with step 310 of obtaining real-time records of positions of sports game players and a game object within a playing ground. As mentioned above, the records are originated from a sensor arrangement including an imaging camera, a GPS sensor or a radar. The obtained records belonging to predetermined time period 13 are inquired by the processor at step 320. On the basis of the obtained real-time records, successive probable future positions of the sports game players and game object within said playing ground are predicted. The aforesaid probable future positions are predicted for fourth predetermined time period 14 following the third predetermined period of time by performing the previously trained generative adversarial network algorithm (step 330). The predicted future positions of the sports game players and game object within the playing ground are output via the user interface.

According to one embodiment of the present invention, the generative adversarial network algorithm comprises a step of parameterizing the successive probable positions by applying at least one predetermined sports game technique such as dribbling, or passing or shooting or heading or throwing the game object (soccer ball) from one game player to another or like.

According to another embodiment of the present invention, the memory comprises personal records of sports game players. The generative adversarial network algorithm comprises parameterizing the successive probable positions by applying said personal records of sports game players and selecting a candidate to be a substitute in the sports game.

According to a further embodiment of the present invention, the generative adversarial network algorithm comprises modelling a fake game parameterized by said applying said at least one predetermined sports game technique and by applying said personal records of sports game players grouped into rival teams.

According to a further embodiment of the present invention, future fake scenarios for shortening or nullifying latency are generated in real time. Generation of fake scenarios is especially useful for the broadcasting and betting embodiments of the present invention where shortening or nullifying the latency is mostly beneficial.

While the invention has been particularly shown and described with reference to an embodiment thereof, it will be appreciated by those skilled in the art that various changes in form and detail may be made without departing from the spirit and scope of the invention.

1.-37. (canceled)

38. A computer-implemented system for assisting a sports game analyst, comprising:
a. a user interface operable to interact with a user;
b. a memory storing records of positions of sports game players and game object within a playing ground; said memory comprises personal records of said sports game players;
c. a processor cooperatively operable with said user interface and said memory; said processor configured for performing an artificial intelligence (AI) algorithm, said AI algorithm comprising a generative adversarial network algorithm trained by steps of:
i. inquiring records of positions of said sports game players and game object within said playing ground for a first predetermined period of time;
ii. generating successive probable positions of said sports game players and game object within said playing ground for a second predetermined period of time within said first predetermined period of time;
iii. discriminating between corresponding generated probable positions and said records; and
iv. validating correctness of said generated probable positions relative to said real-time positions; and
d. a sensor configured for detecting and transmitting real-time positions of said sports game players and game object within said playing ground to said processor; said sensor is selected from the group consisting of a radar, an optical control sensor, a GPS wearable, an RFID beacon, and any combination thereof;
wherein said processor is configured for inquiring real-time positions of said sports game players and game object and predicting future positions of said sports game players and game object within said playing ground by performing said AI algorithm.

39. The system according to claim 38, wherein said sports game is soccer.

40. The system according to claim 38, wherein said generative adversarial network algorithm comprises parameterizing said successive probable positions by applying at least one predetermined sports game technique; said sports game technique is selected from the group consisting of a single lunge, a rabona, a stepover, a Cruyff turn, an inside rollover, a Matthews cut, an ellastico, an around-the-world, a Ronaldo chop and any combination thereof.

41. The system according to claim 38, wherein said personal records are selected from the group consisting of ball control skills, dribbling skills, tackling skills, heading skills, dead ball skills, passing accuracy, body control skills, spatial awareness, tactical knowledge, risk assessment, physical endurance, balance and coordination, speed, and any combination thereof.

42. The system according to claim 38, wherein said generative adversarial network algorithm comprises parameterizing said successive probable positions by applying said personal records of sports game players and selecting a candidate to be a substitute in said sports game.

43. The system according to claim 42, wherein said applying said personal records of sports game players comprises outputting recommended game formation and scenario of a sports game performed by alternative game players characterized by said personal records; said game formation is selected from the group consisting of 4-5-1, 4-3-3, 4-2-3-1, 3-5-2, 4-4-2, 3-4-2, and any combination thereof; said game scenario is selected from the group consisting of a tiki-taka scenario, a park-the-bus scenario, a counter-attack scenario, a high-press scenario, a long-ball scenario, and any combination thereof.

44. The system according to claim 38, wherein said system is configured for outputting a recommendation to a coach indicating which players to substitute during a match and an optimal team line-up for the coming match.

45. The system according to claim 38, wherein said system is configured for modelling a dribbling-and-losing-the-ball game episode performed by one player and predicting an alternative outcome of said episode performed by another player.

46. The system according to claim 38, wherein said system is configured for modelling a scenario of a team attack if player A plays instead of player B.

47. A computer-implemented method of assisting a sports game analyst, comprising steps of:
a. providing a computer-implemented system for assisting a sports game analyst, comprising:
i. a user interface operable to interact with a user;
ii. a memory storing records of positions of sports game players and game object within said playing ground; said memory comprising personal records of said sports game players;
iii. a processor cooperatively operable with said user interface and memory; said processor configured for performing an artificial intelligence (AI) algorithm; said AI algorithm comprising a generative adversarial network algorithm trained by steps of:
(a) inquiring records of positions of said sports game players and game object within said playing ground for a first predetermined period of time;
(b) generating successive probable positions of said sports game players and game object within said playing ground for a second predetermined period of time within said first predetermined period of time;
(c) discriminating between corresponding generated probable positions and said records; and
(d) validating correctness of said generated probable positions relative to said real-time positions; and
iv. a sensor configured for detecting real-time positions of said sports game players and game object within said playing ground; said sensor is selected from the group consisting of a radar, an optical control sensor, a GPS wearable, an RFID beacon, and any combination thereof;
b. inquiring records of real-time positions of said sports game players and game object within said playing ground for a third predetermined period of time;
c. predicting probable future positions of said sports game players and game object within said playing ground by performing said AI algorithm; and
d. outputting predicted future positions of said sports game players and game object within said playing ground via said user interface.

48. The method according to claim 47, further comprising a step of selecting said sports game to be soccer.

49. The method according to claim 47, further comprising a step of detecting real-time positions of said sports game players and game object within said playing ground and transmitting obtained real-time positions of sports game players and game object within said playing ground to said processor.

50. The method according to claim 47, further comprising a step of said generative adversarial network algorithm parameterizing said successive probable positions by applying at least one predetermined sports game technique; said sports game technique is selected from the group consisting of a single lunge, a rabona, a stepover, a Cruyff turn, an inside rollover, a Matthews cut, an ellastico, an around-the-world, a Ronaldo chop, and any combination thereof.

51. The method according to claim 47, further comprising a step of selecting said personal records from the group consisting of ball control skills, dribbling skills, passing accuracy, body control skills, spatial awareness, tactical knowledge, risk assessment, physical endurance, balance and coordination, speed, and any combination thereof.

52. The method according to claim 47, further comprising a step of modelling a fake game between rival teams and generating a game outcome on a basis of said personal records of said rival teams.

53. The method according to claim 47, further comprising a step of said generative adversarial network algorithm parameterizing said successive probable positions by applying said personal records of sports game players and selecting a candidate to be a substitute in said sports game.

54. The method according to claim 47, further comprising a step of applying said personal records of sports game players comprises outputting recommended game formation and scenario of a sports game performed by alternative game players characterized by said personal records; said game formation is selected from the group consisting of 4-5-1, 4-3-3, 4-2-3-1, 3-5-2, 4-4-2, 3-4-2, and any combination thereof; said game scenario is selected from the group consisting of a tiki-taka scenario, a park-the-bus scenario, a counter-attack scenario, a high-press scenario, a long-ball scenario, and any combination thereof.

55. The method according to claim 47, further comprising a step of outputting a recommendation to a coach indicating which players to substitute during a match and an optimal team line-up for the coming match.

56. The method according to claim 47, further comprising a step of modelling a dribbling-and-losing-the-ball game episode performed by one player and predicting an alternative outcome of said episode performed by another player.

57. The method according to claim 56, further comprising a step of modelling a scenario of a team attack if player A plays instead of player B.
